(19) United States
(12) Patent Application Publication
(10) Pub. No.: US 2015/0063074 A1
(43) Pub. Date: Mar. 5, 2015

(54) APPARATUS AND METHOD FOR PROVIDING A CUSTOMIZED INPUT-SERVICE

(71) Applicant: Hyundai Motor Company, Seoul (KR)

(72) Inventors: Kwang Myung Oh, Daejeon (KR); Hui Sung Lee, Gunpo (KR); Sung Min Park, Seoul (KR); Sung Jin Sah, Suwon (KR)

(73) Assignee: HYUNDAI MOTOR COMPANY, Seoul (KR)

(21) Appl. No.: 14/081,215

(22) Filed: Nov. 15, 2013

(30) Foreign Application Priority Data
Sep. 2, 2013 (KR) 10-2013-0104739

(51) Int. Cl. G08C 23/02; B60R 16/023

(52) U.S. Cl. CPC G08C 23/02; B60R 16/023
USPC 367/197

(57) ABSTRACT

An apparatus and method that provide a customized input-service is provided. The apparatus includes at least one input unit that generates an sound wave based on an exterior input and a sound wave sensor that converts an sound signal for the sound wave into an electric signal. In addition, a controller analyzes the electric signal received from the sound wave sensor to confirm where the exterior input is generated and detects a control signal based on the exterior input and performs an operation based on the control signal from operations allocated to the input unit.

### CROSS-REFERENCE TO RELATED APPLICATION

This application claims the benefit under 35 U.S.C. §119(a) of a Korean patent application filed in the Korean Intellectual Property Office on Sep. 2, 2013 and assigned Serial No. 2013-0104739, and the entire disclosure of which is hereby incorporated by reference.

### BACKGROUND

1. Field of the Invention

The present invention relates to an apparatus and method that provide a customized input-service, and more particularly, to an apparatus that provides a customized input-service to improve an operation convenience of an operator, and provides a sound feedback for each input unit and a physical operation feeling of an input unit by coupling an input unit to a particular location of electronic equipment based an operator's propensity in order to operate the electronic equipment.

2. Description of the Related Art

Generally, a center-fascia installed within a vehicle is equipped with control buttons to operate a sound device such as a car audio and a compact disc (CD) player, a display device such as a navigation and a digital multimedia broadcasting (DMB), an air conditioning device such as an air conditioner and a heater, and the like.

The center-fascia, which is a section of a dash-board, is fixed to a bracket to be positioned at the front-center of the vehicle. The driver frequently checks the center-fascia while driving the vehicle and manipulates the devices such as the sound device, the display device, the air conditioning device, and the like installed on the center-fascia. In particular, the driver manipulates a control knob disposed on the center-fascia to operate a function such as an on/off, a volume control, and a menu change of the sound device and the display device. In addition, the driver controls a temperature and a wind speed of the air conditioner or the heater by manipulating the control knob disposed on the center-fascia, and a wind direction by an adjustable grille of a vent.

However, in the related art, when operating a device such as the sound device, the display device, and the air conditioning device, the driver needs to search and operate a control button such as a control knob of the device to be operated while driving the vehicle. Therefore, it may be difficult to maintain a forward gaze, thus increasing the risk of accident. In addition, since the related art requires a cable that generates and transmits an electrical signal based on the driver's input to each of the control buttons such as the control knob, the manufacturing cost may increase as the number of control buttons increases.

### SUMMARY

The present invention provides an apparatus and method that provide a customized input-service to facilitate an operation of a device by disposing an input unit at a particular location to allow an operator to use an input-service based on own propensity.

The present invention further provides an apparatus and method that provide a customized input-service to facilitate an operation of a device while driving the vehicle, reduces a malfunction of the device, and improves the degree of freedom in designing the panel or the console by disposing an input unit on a panel or a console including a center-fascia panel of a vehicle based on driver preference.

The present invention further provides an apparatus and method that provide a customized input-service which forms an input unit by a material or a form that generates a particular sound wave when operating to improve a physical operation feeling and improve an operation recognition rate through a sound feedback for each input unit, and reduce a cost by equipping a sound wave sensor that recognizes a specific sound wave.

In accordance with an aspect of the present invention, an apparatus that provides a customized input-service may include: at least one input unit configured to generate an sound wave based on an input from an exterior; a sound wave sensor configured to convert a sound wave signal of the sound wave into an electric signal; and a controller configured to analyze the electric signal received from the sound wave sensor to confirm the input unit where the input is generated and a control signal based on the input, and configured to perform an operation based on the control signal among operations allocated to the input unit. The input unit may include a button that generates a particular sound wave by the input from the exterior, a rotary key, and a sliding key, and an input device having a structure in which a plurality of protrusions may be formed on an upper surface of the input unit to generate the particular sound wave by a friction.

Furthermore, the input unit may be disposed on an upper surface of the sound wave sensor. The input unit may be formed in an adhesion structure including a double-sided tape, a hook and loop fastener, and a plastic pad, and may be closely adhered to the upper surface of the sound wave sensor. The input unit may be attached and detached to and from the sound wave sensor and may be formed in a fastening structure including a concave-convex, a latch, and a permanent magnet, and may be fastened to the upper surface of the sound wave sensor. Additionally, the input unit may be formed in a particular location including a center fascia panel, a center console, a door control panel, an overhead console, a crash pad, a steering wheel, and an arm rest of a vehicle. The input unit may be configured to generate different sound wave for each of the input units and may be configured to provide a hearing or touch feedback based on an input generated in the input unit to a driver. The sound wave sensor may be formed in a portion of or the entire particular location.

### BRIEF DESCRIPTION OF THE DRAWINGS

The objects, features and advantages of the present invention will be more apparent from the following detailed description in conjunction with the accompanying drawings, in which:

FIG. 1 is an exemplary block diagram illustrating a main configuration of an apparatus that provides a customized input-service according to an exemplary embodiment of the present invention;

FIG. 2 is an exemplary diagram illustrating an input unit of an apparatus that provides a customized input-service installed on a center fascia according to an exemplary embodiment of the present invention;

FIG. 3 is an exemplary diagram illustrating a change of an input unit of an apparatus that provides a customized input-service installed on a center fascia according to an exemplary embodiment of the present invention; and

FIGS. 4A to 11 are exemplary cross-sectional diagrams illustrating a structure of an input unit of the apparatus that provides a customized input-service shown FIG. 1 according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Exemplary embodiments of the present invention are described in detail with reference to the accompanying drawings. The same reference numbers are used throughout the drawings to refer to the same or like parts. Detailed descriptions of well-known functions and structures incorporated herein may be omitted to avoid obscuring the subject matter of the present invention.

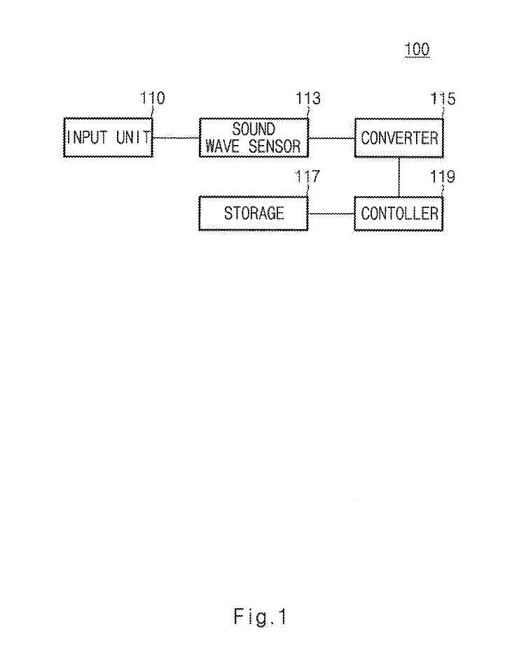

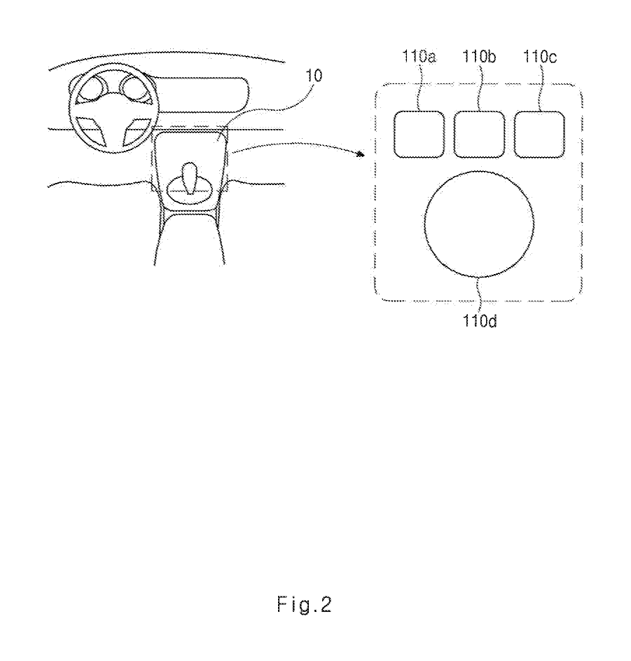

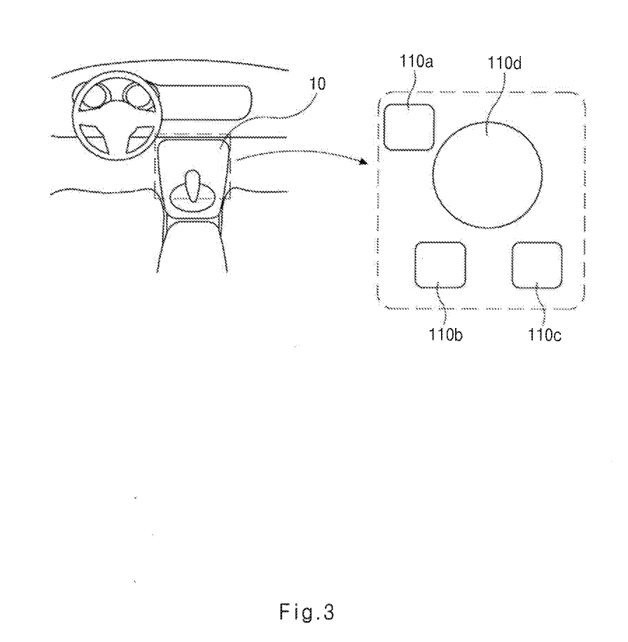

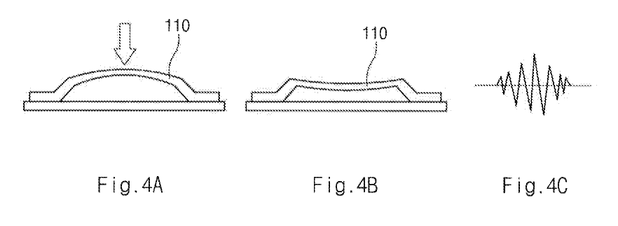

FIG. 1 is an exemplary block diagram illustrating a main configuration of an apparatus that provides a customized input-service according to an exemplary embodiment of the present invention. FIG. 2 is an exemplary diagram illustrating an input unit of an apparatus that provides a customized input-service installed on a center fascia according to an exemplary embodiment of the present invention. FIG. 3 is an exemplary diagram illustrating a change of an input unit of an apparatus that provides a customized input-service installed on a center fascia according to an exemplary embodiment of the present invention. FIGS. 4 to 11 are exemplary cross-sectional diagrams illustrating a structure of an input unit of the apparatus that provides a customized input-service shown in FIG. 1 according to an exemplary embodiment of the present invention.

Referring to FIGS. 1 to 11, an apparatus 100 (hereinafter, referred to as control device) that provides a customized input-service according to the exemplary embodiment of the present invention may include an input unit 110, an sound wave sensor 113, a converter 115, a storage 117, and a controller 119.

The input unit 110 may include a button that generates a particular sound wave, a rotary key and a sliding key and an input device that has a structure in which a plurality of protrusions are formed on an upper surface generating the particular sound wave by friction. A plurality of input units may be positioned at a center-fascia 10 of a vehicle as shown in FIG. 2.

Further, the input unit 110 may be adhered or fastened to an upper surface of the sound wave sensor 113. In particular, the input unit 110 may be formed in an adhesion structure that may include a double-sided tape, a hook and loop fastener and a plastic pad, and may be formed in a fastening structure that may include a concave-convex shape, a latch, and a permanent magnet, to adhere or fasten the input unit 110 to the upper surface of the sound wave sensor 113.

Additionally, various functions may be allocated to each type of input unit 110 and different sound signals may be generated for each different input unit 110. For example, an audio device control function, a vehicle internal lighting control function, an cooling and heating control function and AVN (audio, video and navigation) screen control function may be allocated to a first input unit 110a, a second input unit 110b, a third input unit 110c, and a fourth input unit 110d of the input unit 110, respectively.

In addition, the driver may arbitrarily change the function allocated to each input unit 110. Furthermore, the driver may change a position of the input unit 110 by disposing the fourth input unit 110d in an upper portion of the center fascia 10 and the first, second, and third input units 110a, 110b, and 110c in a lower portion thereof. Alternatively, the center fascia 10 may be reconfigured by selecting the type of the input unit 110 to be fastened to the sound wave sensor 113. The center fascia 10 configured as shown in FIG. 2 may be reconfigured based on driver preference as shown in FIG. 3. Therefore, when the input unit 110 is manipulated to perform a desired function, an intuitive operation may be improved. In addition, the input unit 110 may be designed in various firms (e.g., may be a separate element) and the input unit 110 may be fastened to the center fascia 10.

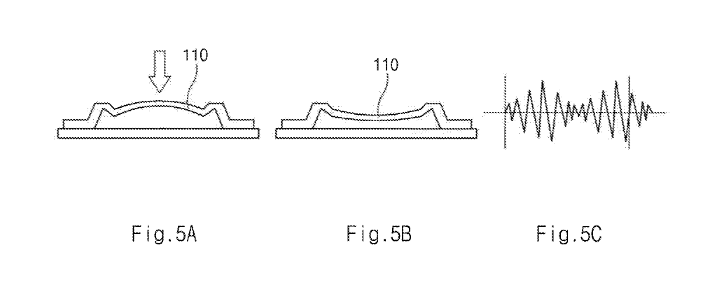

The input unit 110 may be formed in the structure shown in FIGS. 4 to 11. In particular, as shown FIGS. 4A-4C and 5A-5C, the input unit 110 may be formed with a thin plate of a material having elasticity and may be formed as a structure in which the sound wave may be generated by performing transformation and restoration when the driver applies the pressure to the input unit 110. In other words, the input unit may be pressed and due to the pressure may be deformed, generating a sound wave. The input unit 110 may be formed of an elastic material such as a metal plate, a plastic plate, and the like. Specifically, FIGS. 4A and 5A show the input unit 110 formed as a type of button, respectively. As shown in FIGS. 4A and 5A, pressure may be applied to a portion of the button to change the form of the button as shown in FIGS. 4B and 5B, and when the pressure is released, the input unit 110 may be restored to an original form as shown in FIGS. 4A and 5A. In addition, FIGS. 4C and 5C represent a signal that measures the sound wave generated when the form of the button is changed by the pressure applied to the input unit 110 and then is restored to an original form by removing the pressure.

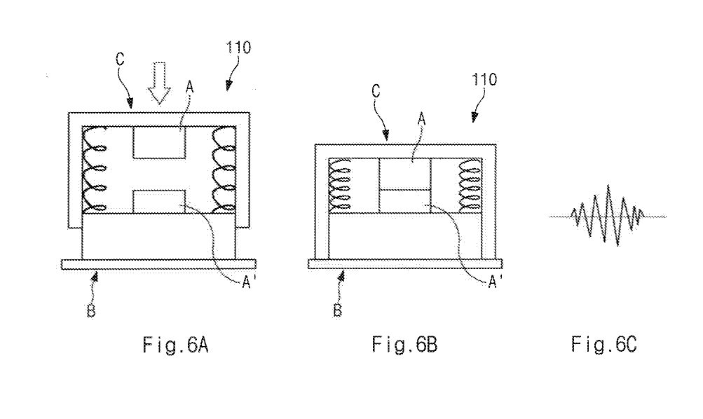

As shown in FIGS. 6A-6C, the input unit 110 may be formed in a structure in which the sound wave may be generated due to an impact between structures disposed within the input unit 110 when pressure is applied to the input unit 110. In particular, the input unit 110 may include sound generating structures A and A′, a bottom surface B, and a case C. When pressure is not applied to the input unit 110, the case C may be spaced apart from the bottom surface B by a spring formed within the case C. Additionally, the sound generating structures A and A′ may be disposed to be opposite to the bottom surface B and the case C, respectively. In particular, the sound generating structure A formed on the case C may be spaced apart from the sound generating structure A′ formed on the bottom surface B when pressure is not applied to the input unit 110. When pressure is applied to the particular portion of the input unit 110 as shown in FIG. 6A, the case C is lowered toward the bottom surface B as shown in FIG. 6B. Therefore, the input unit 110 may generate the sound wave as shown in FIG. 6C due to the collision between the sound generating structure A formed on the case C and the sound generating structure A′ formed on the bottom surface B. FIG. 6C represents a signal that measures the sound wave generated due to the collision (e.g., the contract) between the sound generating structures A and A′.

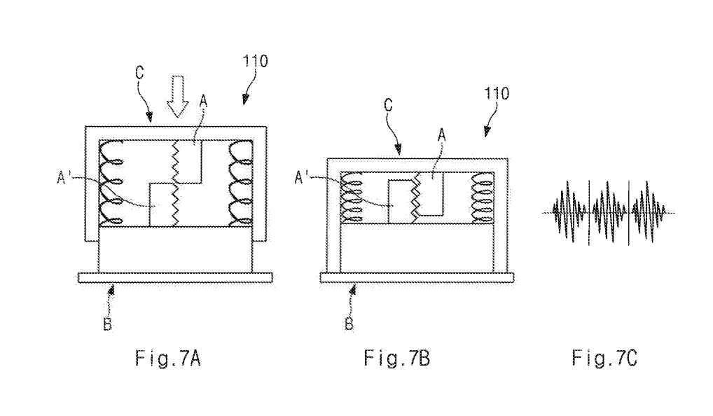

As shown in FIGS. 7A-7C, the input unit 110 may be formed in a structure in which the sound wave is generated due to a friction between structures disposed within the input unit 110 when pressure is applied to the input unit 110. Since the structure as shown in FIGS. 7A-7C, except for the sound generating structures A and A′, is similar to the structure of the input unit 110 as shown in FIGS. 6A-6C, the detailed description thereof will be omitted. When pressure is applied to the particular location of the input unit 110 as shown in FIG. 7A, the case C lowers toward the bottom surface B as shown in FIG. 7B. Therefore, the input unit 110 may generate the sound wave as shown in FIG. 7C due to the friction between the sound generating structure A formed on the case C and the sound generating structure A′ formed on the bottom surface B. FIG. 7C represents a signal that measures the sound wave generated due to the friction between the sound generating structures A and A′.

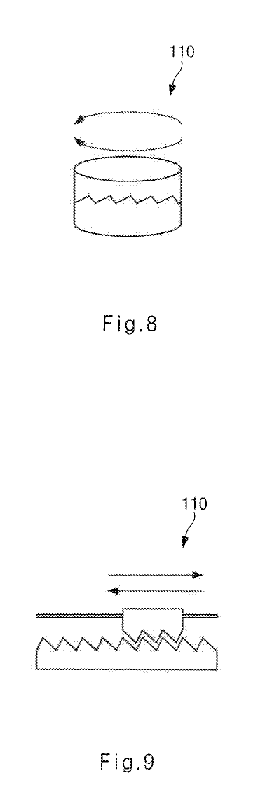

Moreover, the input unit 110 may be formed as a rotary key type as shown in FIG. 8, when pressure is applied to the input unit 110 in a particular direction to rotate the input unit 110, the input unit 110 may be formed in a structure in which the sound wave is generated due to the friction between the structures of the input unit 110. In addition, the input unit 110 may be formed as a sliding key type as shown in FIG. 9, when pressure is applied to the input unit 110 in the particular direction to slide the input unit 110, the input unit 110 may be formed in a structure in which the sound wave is generated due to the friction between the structures configuring the input unit 110.

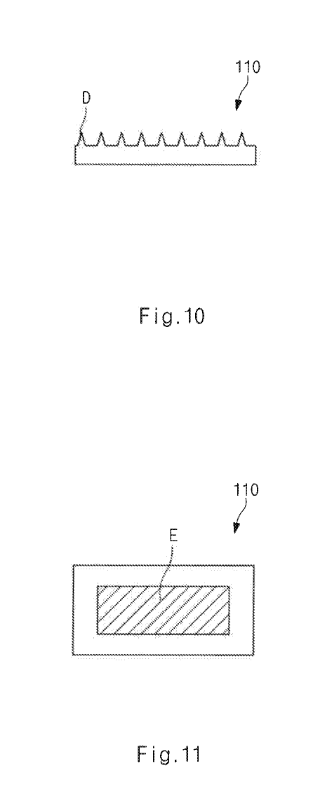

Furthermore, the input unit 110 may be formed with a plurality of protrusions D as shown in FIG. 10. In particular, the input unit 110 may be formed in a structure in which the roughness of the surface of the input unit 110 may be designed to generate a different sound wave based on the protrusions D when the protrusions D are moved or contacted (e.g., when an object is moved along the protrusions D). In addition, the protrusions D may be formed in a semicircular form.

FIG. 11 is an exemplary diagram illustrating a top view of the input unit 110. In particular, reference numeral E indicates a space formed in a substantially central portion of the input unit 110. The input unit 110 may be formed in a structure in which the sound wave is generated by generating vibrations in the structure itself of the input unit 110 by tapping the space E. The space E formed in the substantially central portion of the input unit 110 may generate the different sound waves based on conditions such as a size and depth of the space E and the material forming the input unit 110. In addition, the input unit 110 may he formed in a structure in which the driver may feel a physical operation feeling for each input unit 110 at the time of operating the input unit 110 and may provide a sound feedback for each input unit 110 to the driver, to improve an operation recognition rate of the input unit 110.

When the sound signal is generated due to the input generated from the input unit 110 fastened to the center fascia 10 among the above-mentioned elements, the sound wave sensor 113 may be configured to convert the generated sound signal into an electric signal to provide the converted electric signal to a converter 115. Particularly, the sound wave sensor 113 may be configured to recognize the sound signal generated in the different input units 110a-110d. The converter 115 may be configured to convert the electric signal received from the sound wave sensor 113 into a digital signal to provide the digital signal to a controller 119. The storage 117 may be configured to store a control signal that corresponds to the function allocated to the plurality of input units 110a-110d. The controller 119 may be configured to confirm from the input unit 110 in which the input is generated from the exterior by analyzing the digital signal received from the converter 115, and may be configured to perform an operation stored by mapping to the input unit 110.

In particular, the controller 119 may be configured to confirm from the input unit 110 where the input is generated by the driver. The controller 119 may be configured to execute the input unit 110 based on the driver input. In addition, the input unit 110 according to the exemplary embodiment of the present invention may include a first input unit 110a, a second input unit 110b, a third input unit 110c, and a fourth input unit 110d as shown in FIGS. 2 and 3, and may be configured to execute the control signal that corresponds to the each function stored in the storage 117 when different functions are mapped to each input unit 110. Specifically, the first input unit 110a may be configured to operate the audio device, the second input unit 110b may be configured to operate the lighting within the vehicle, the third input unit 110c may be configured to operate the cooling and heating, and the fourth input unit 110d may be configured to operate the AVN screen.

As a result of analyzing the digital signal provided though the converter 115, when the sound wave signal which is the original signal of the digital signal is a signal generated in the first input unit 110a, the controller 119 may be configured to recognize the sound signal as a signal to operate the audio device. The controller 119 may be configured to analyze the signal to determine a function that the signal requests from the signals that operate the audio device to perform the corresponding function according to the pattern of the analyzed digital signal. In particular, the signal to operate the audio device may he a signal for an increase or decrease function of the volume, equalization function, and shuffle function.

Additionally, when the signal is input to change a preset function for each input unit 110 by the driver, the controller 119 may be configured to change the preset function for each input unit 110 into the input function based on the input signal. In other words, the first input unit 110a may be changed to operate the cooling and heating and the second input unit 110b may be changed to operate the audio device.

For convenience of explanation, although the present exemplary embodiment describes the case in which the control device 100 is disposed on the center fascia 10 of the vehicle, the present invention is not limited thereto. The control device 100 may be disposed in a position capable of operating the electronic equipment such as a mobile terminal, a center fascia of the center console, a door control panel, an overhead console, a crash pad, a steering wheel, and an arm rest of a vehicle.

As set forth above, the exemplary embodiment according to the present invention provides a customized input-service which facilitates an operation of a convenience device by disposing an input unit at a particular location to allow an operator to use an input-service based on driver preference. Further, the exemplary embodiment according to the present invention provides a customized input-service which facilitates an operation of a convenience device while driving the vehicle, reducing a malfunction of the convenience device, and improving the degree of freedom in designing the panel or the console by disposing an input unit on a panel or a console including a center-fascia panel of a vehicle based on driver preference.

Additionally, the exemplary embodiment according to the present invention provides a customized input-service which forms an input unit by a material or a form that generates a specific sound wave when operated to improve a physical operation feeling and improve an operation recognition rate through a sound feedback for each input unit, and reduce a cost by equipping a sound wave sensor for recognizing a specific sound wave.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the accompanying claims.

What is claimed is:

1. An apparatus that provides a customized input-service, comprising:
at least one input unit configured to generate an sound wave based on an exterior input;
a sound wave sensor configured to convert a sound wave signal for the sound wave into an electric signal; and
a controller configured to:
analyze the electric signal received from the sound wave sensor to confirm where the input is generated and detect a control signal based on the exterior input; and
perform an operation based on the control signal from operations allocated to the input unit.

2. The apparatus of claim 1, wherein the input unit includes a button configured to generate a specific sound wave by the exterior input, a rotary key, and a sliding key, and an input device having a structure in which a plurality of protrusions are formed on an upper surface of the input unit generating the specific sound wave by a friction.

3. The apparatus of claim 2, wherein the input unit is positioned on an upper surface of the sound wave sensor.

4. The apparatus of claim 3, wherein the input unit is adhered to the upper surface of the sound wave sensor and is formed in an adhesion structure selected from a group consisting of: a double-sided tape, a hook and loop fastener, and a plastic pad.

5. The apparatus of claim 4, wherein the input unit is detachable from the sound wave sensor.

6. The apparatus of claim 3, wherein the input unit is fastened to the upper surface of the sound wave sensor and is formed in a fastening structure selected from a group consisting of: a concave-convex shape, a latch, and a permanent magnet.

7. The apparatus of claim 6, wherein the input unit is detachable from the sound wave sensor.

8. The apparatus of claim 1, wherein the input unit is formed in a particular location selected from a group consisting of: a center fascia panel, a center console, a door control panel, an overhead console, a crash pad, a steering wheel, and an arm rest of the vehicle.

9. The apparatus of claim 1, wherein the apparatus includes a plurality of input units.

10. The apparatus of claim 9, wherein the input unit generates a different sound wave for each input unit.

11. The apparatus of claim 1, wherein the input unit provides a hearing or touch feedback based on an input generated in the input unit to a driver.

12. The apparatus of claim 8, wherein the sound wave sensor is formed of in the entire particular location.

13. A method of providing a customized input-service, comprising:
receiving, by a controller, an electric signal from a sound wave sensor converted from a sound wave signal for a sound wave generated by an input unit based on an exterior input;
analyzing, by the controller, the electric signal received from the sound wave sensor to confirm where the input is generated and detect a control signal based on the exterior input; and
performing, by the controller, an operation based on the control signal from operations allocated to the input unit.

14. The method of claim 13, wherein the input unit includes a button configured to generate a specific sound wave by the exterior input, a rotary key, and a sliding key, and an input device having a structure in which a plurality of protrusions are formed on an upper surface of the input unit generating the specific sound wave by a friction.

15. The method of claim 14, wherein the input unit is positioned on an upper surface of the sound wave sensor.

16. The method of claim 15, wherein the input unit is adhered to the upper surface of the sound wave sensor and is formed in an adhesion structure selected from a group consisting of: a double-sided tape, a hook and loop fastener, and a plastic pad.

17. The method of claim 15, wherein the input unit is detachable from the sound wave sensor.

18. The method of claim 14, wherein the input unit is formed in a particular location selected from a group consisting of: a center fascia panel, a center console, a door control panel, an overhead console, a crash pad, a steering wheel, and an arm rest of the vehicle.
